(19) United States
(12) Patent Application Publication
(10) Pub. No.: US 2008/0229280 A1
(43) Pub. Date: Sep. 18, 2008

(54) Systems and methods for composing custom applications from software components

(75) Inventor: Frank Stienhans, San Carlos, CA (US)

Correspondence Address: Chad R. Walsh;Fountainhead Law Group PC, Ste. 509, 900 Lafayette St., Santa Clara, CA, 95050, US

(73) Assignee: SAP AG, Walldorf (DE)

(21) Appl. No.: 11/716,767

(22) Filed: Mar. 12, 2007

(51) Int. Cl. G06F 9/44

(52) U.S. Cl. 717/107

(57) ABSTRACT

Embodiment the present invention includes systems and methods for composing custom applications from software components. In one embodiment, the present invention includes a method of composing a software application comprising selecting a plurality of software components, wherein each software component includes a predefined functionality, determining the compatibility of the selected software components with a first container; associating the software components with the first container if the software components are compatible with the first container, and activating the first container, and in accordance therewith, activating the predefined functionality of each of the plurality of associated software components.

### BACKGROUND

The present invention relates to computer software applications, and in particular, to systems and methods for composing custom applications from software components.

Computer software applications were traditionally created by computer programmers implementing certain specified functionality in computer source code. Typically, the desired functionality of the software application is specified first. Next, the source code is written to implement specified functions. Finally, the source code is compiled and linked into a computer software application that can be executed on a computer system by a user.

Over time, many types of computer applications have been created, and it has been desirable to allow various software applications to work together to implement more comprehensive functionality. However, in order for software applications to work together, yet more programming is required to create software frameworks that allow different software applications to communicate with each other and control the use of each application's functionality in a higher level process. Business Process Markup Languages (“BPML”), for example, have been used for this purpose.

However, the programming necessary to compose different applications or other types of software components into customized applications with enhanced functionality is time consuming and costly. Expensive computer programming specialists are typically required, and complex specifications and architectures for tying software components together must be specified. The resulting cycle times for such projects can be long. Thus, it would be desirable to improve the technology available for composing software applications from software components.

Another example software component is a software “widget” (sometimes called a “gadget”). A software widget (“widget”) is an application accessible by a user (e.g., via the desktop) that provides one or more particular functions. The usage of the term widget in this specification is to be distinguished from mere graphical components such as a button, cursor, or other virtual mechanisms used in a graphical user interface because such virtual components are not applications by themselves and have no underlying processing algorithms or functionality. Example widgets include news aggregators, clocks, calculators, calendars, desktop notes, or weather forecasts. As illustrated in FIG. 1, widgets are typically represented as icons on a computer display. The icons may display information and provide input/output mechanisms for entering data and presenting the results. Widgets typically include one or more images that may be displayed on the GUI and may further include less than ten to several hundred lines of XML, JavaScript, or VBScript, depending on complexity, to implement the widget's logic. As illustrated in FIG. 1, widgets are typically distinct applications residing on the desktop. The widgets 110A-C may be presented on the computer display 101 as icons, for example. Some widgets may be invoked by “clicking,” “rolling over,” or otherwise selecting the widget with a mouse or other user input device. Some widgets may then display user input fields and display output fields, for example. However, while each widget may provide some distinct functionality, the functionality of each widget is not easily composed into more complex widgets with combined functionality.

Software services are another type of software application component. Software services are typically atomic programs that may be combined and/or used by other programs. As with applications and widgets, composing software services typically requires the work of programmers.

One existing technique for combining the functionality of software components is a “portal,” such as an enterprise portal. An enterprise portal is a framework for integrating information, applications, and processes across organizational boundaries. However, to integrate applications and other software functionality into a portal, system administrators must typically create mappings between the various programs, applications, or other software components being integrated into the portal. Such mappings are typically created using metadata or metadata-like languages by a programmer or system administrator, and therefore suffer from similar cost, complexity, and time problems mentioned above.

Thus, there is a need for improved systems and methods for creating software applications from software components that does not require the time and expense of professional programmers or administrators. The present invention solves these and other problems by providing improved systems and methods for composing custom applications from software components.

### SUMMARY

Embodiments of the present invention include systems and methods for composing custom applications from software components. In one embodiment, the present invention includes a method of composing a software application comprising selecting a plurality of software components, wherein each software component includes a predefined functionality, determining the compatibility of the selected software components with a first container; associating the software components with the first container if the software components are compatible with the first container, and activating the first container, and in accordance therewith, activating the predefined functionality of each of the plurality of associated software components.

In another embodiment, the present invention includes a computer software system comprising a software engine, a first container, and a plurality of software components associated with the first container, each software component having predefined functionality, wherein a user associates compatible software components with the first container to create a composite application including the functionality of each of the software components, and wherein the plurality of software components are automatically activated by the software engine if the first container is activated.

The following detailed description and accompanying drawings provide a better understanding of the nature and advantages of the present invention.

### BRIEF DESCRIPTION OF THE DRAWINGS

FIG. 1 illustrates existing widgets presented in a typical computer display.

FIG. 2A illustrates a container for composing software components according to an embodiment of the present invention.

FIG. 2B illustrates the relationships between a container and different software components according to an embodiment of the present invention.

FIG. 2C illustrates an application composed from software components according to an embodiment of the present invention.

FIG. 3 illustrates composing software components according to an embodiment of the present invention.

FIG. 4 illustrates the functionality of a composite application according to an embodiment of the present invention.

FIGS. 5A-B show an example application composed from software components according to an embodiment of the present invention.

FIG. 6 shows an example registry of software components according to an embodiment of the present invention.

FIG. 7 shows an example implementation of a customizable application according to an embodiment of the present invention.

FIG. 8 illustrates an example computer system and networks that may be used to implement one embodiment of the present invention.

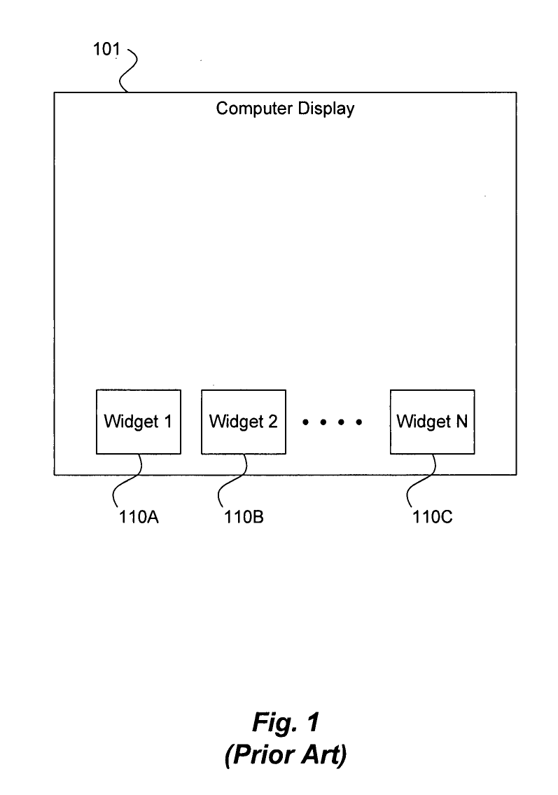

### DETAILED DESCRIPTION

Described herein are techniques for automated composition of custom applications from software components. In the following description, for purposes of explanation, numerous examples and specific details are set forth in order to provide a thorough understanding of the present invention. It will be evident, however, to one skilled in the art that the present invention as defined by the claims may include some or all of the features in these examples alone or in combination with other features described below, and may further include modifications and equivalents of the features and concepts described herein.

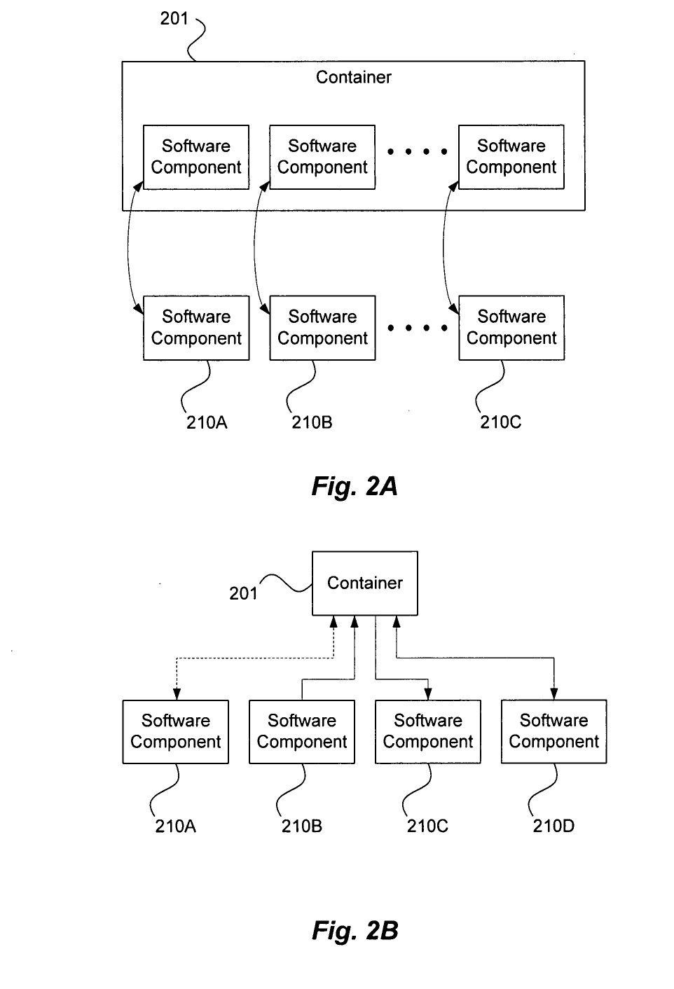

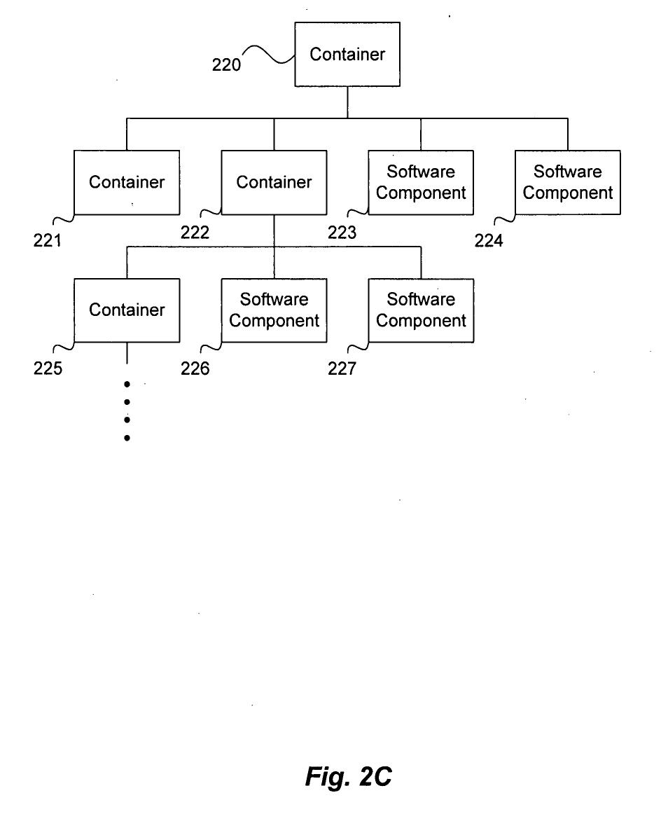

FIG. 2A illustrates a container for composing software components according to an embodiment of the present invention. In one embodiment, the present invention includes a component container 201 for integrating multiple software components 210A-C into a compound application or program. Component container 201 may also be referred to as a “container” or “parent component” (or just “parent”), for example. Container 201 may or may not include any end-user functionality of its own, but includes interfaces that allow different software components with different functionalities to communicate with each other and with external resources. In one embodiment, container 201 may be displayed as a window or icon, and a user may select (e.g., drag and drop) different software components, represented as icons, for example, and place the component in the container window 201. Accordingly, an association between the container 201 and software components 2 1A-C is established. When multiple components 210 are associated with the container 201, the software components may automatically work together in a composite application. Any compatible software components 210 desired by a user may be combined in the container 201 according to the particular functionality desired by a user. Accordingly, users may combine different software components to obtain any desired combination of features and functions. In another embodiment, a composite application may also be decomposed by removing any software components 210 from container 201. A user may drag a software component out of the container using a mouse, for example.

FIG. 2B illustrates the relationships between a container and different software components according to an embodiment of the present invention. Different software components may perform a variety of different functions. Some software components may receive data from a data source. Data may be received from a user, generated automatically by the software component, or retrieved by the software component from external systems. The software component may further process data locally using predefined component logic and display either the data or the processed data to a user. Yet other software components may have inputs, outputs, or both, for passing data between software components in a composite application. In FIG. 2B, software component 210A does not have any inputs or outputs for sending or receiving data internal to the container (but it may have an input or output for sending or receiving data from an external source such as an external database or user). Component 210A is associated with container 201 (as illustrated by the dashed line), but does not communicate information with other components in the container. For example, software component 210A may be a weather forecast widget that includes a connection to an external source of weather data and displays the weather data from the external weather server together with locally stored weather graphics corresponding to the data received from the weather server. Software component 210B may include outputs that may generate data to be communicated to other software components in container 201. Container 201 automatically establishes an interface with software component 210B when component 210B is associated with container 201 (e.g., when component 210B is dragged and dropped into container 201). Accordingly, data may flow out of component 210B to other components associated with the container. Software component 210C may include inputs that may receive data communicated from other software components in container 201. Accordingly, data may flow into component 210C from other components associated with the container. Software component 210D may include inputs and outputs for sending and receiving data from other software components associated with container 201.

FIG. 2C illustrates an application composed from software components according to an embodiment of the present invention. A container may be used to combine the functionality of multiple software components into a composite application. As illustrated in FIG. 2C, container 220 may be associated with multiple software components or other containers that include software components. In this example, container 220 is associated with container 221, container 222, software component 223, and software component 224. Containers 221 and 222 may comprise composite applications that contribute certain functionality to the composite application formed by container 220. Container 222 may include, for example, another container 225 and software components 226 and 227. Accordingly, diverse composite applications may be created by associating software applications with a container to create a composite application.

In one embodiment, atomic software components provide functionality independent of other components in a container. Some software components may include inputs, outputs, or both as described above, for communicating with other components if other components are available. However, some software components may be fully or at least partially functional if the other components do not exist within the container. For example, some software components may have optional outputs that may be used as inputs to other components, but may be ignored if other components that use the outputs are not available in the container. Similarly, some components may have optional inputs, wherein additional component features are available if another component in the container is available to provide the required inputs.

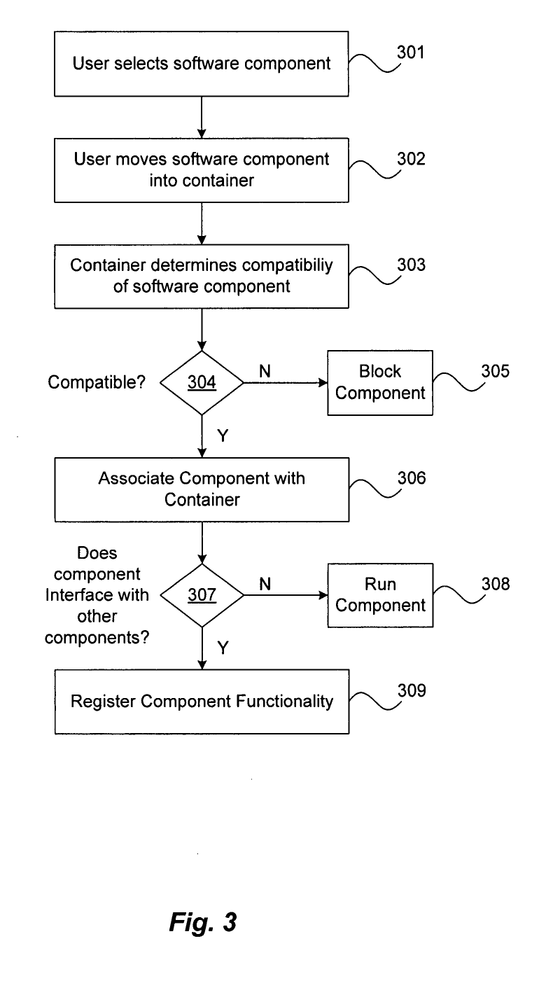

FIG. 3 illustrates composing software components according to an embodiment of the present invention. At 301, a user may select a software component. For example, a user may select a software component represented in a graphical user interface of a computer display and drag-and-drop or copy the component to select it. Embodiments of the invention include selecting components that reside locally, or references to components that reside in a remote location. At 302, the user moves, or otherwise links, the software component into the container to create an association. At 303, the compatibility of the software component with a container may be determined. This may be done either by the container itself as illustrated at 303 or by another piece of software. In one embodiment, the container may include an interface for establishing an association with each component or communications between components, or both. At 304, the compatibility is checked. If a component is not compatible, then the component may be blocked from association with the container at 305. For example, if a component is not compatible with a container, the component icon may change color, become transparent, or the system may generate some other type of visual, auditory, or textual alarm, for example, to notify the user of the compatibility error. At 306, a compatible component is associated with the container. Some components may only be associated with the container, but may not include inputs or outputs for receiving or sending data to other components in the container. Once associated, such components may perform their functions (e.g., gathering input data and displaying the data). However, some components may interface with other components within the container. These components may require additional configuration to establish the communication links between the components (e.g., via the container interface). For example, at 307 a check is made to determine if a component interfaces with other components. If not, the component may run at 308 as described above. However, if a component does interface with other components, component functionality may be registered, for example.

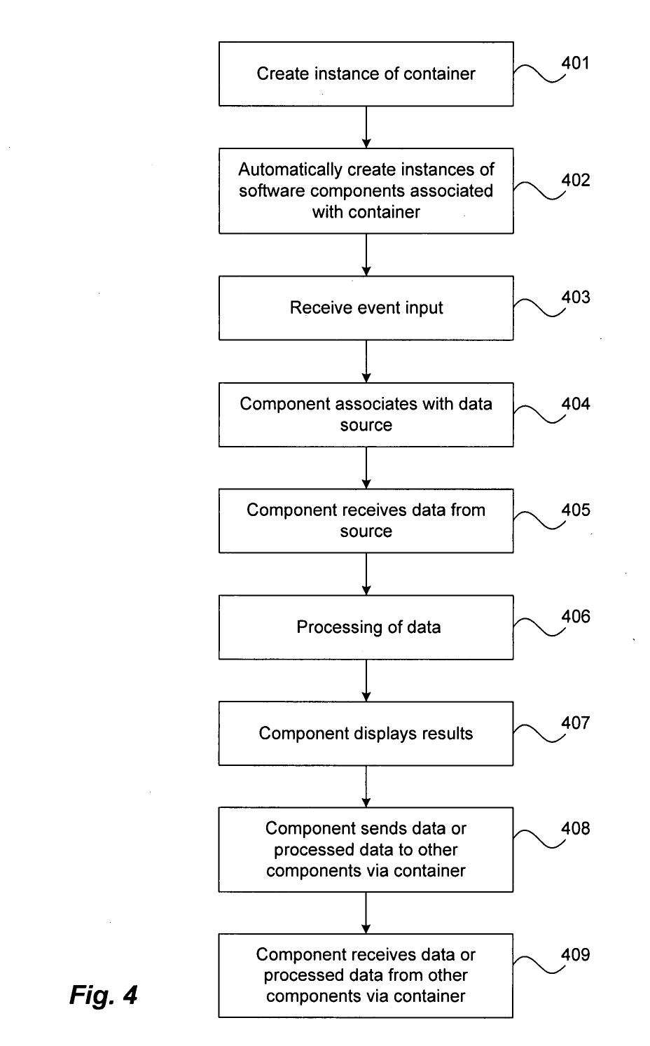

FIG. 4 is an example of a composite application according to an embodiment of the present invention. Once a container is composed with the desired software components, the container may be saved and reused. For example, when a computer system is started, an instance of a container may be created at 401. Additionally, instances of containers may be shared and further modified by sending copies of the container or links to a container to other users. In this manner, information generated by the various software components in a container may be shared among users so that different users can obtain a common view of information. At 402, instances of the software components associated with the container may be automatically created. The system may then receive event inputs from a user at 403. For example, a mouse click from a user may trigger further system activities. At 404, a software component may be associated with a data source. For example, a software component's function may be to access data from an external or internal source, such as one or more applications or databases, or both. Accordingly, at 405 the component receives data from an external or internal source. The software component may receive the data and display it to a user at 407, or the component may perform additional processing on the data at 406 and then present the data to the user at 407. In one embodiment, software components in the container may execute algorithms that present the data in different predefined formats or associate different content with different data, such as images or sounds, for example. While such components in the container may perform complex algorithms and manipulations of data, they may not interface with other components in the container. Other components may perform all these functions and further provide outputs or receive inputs from other components. If a component includes outputs for use by other components in the container, the component may send data or processed data to other components via the container at 408. If a component includes inputs from other components in the container, the component may receive data or processed data from other components via the container at 409.

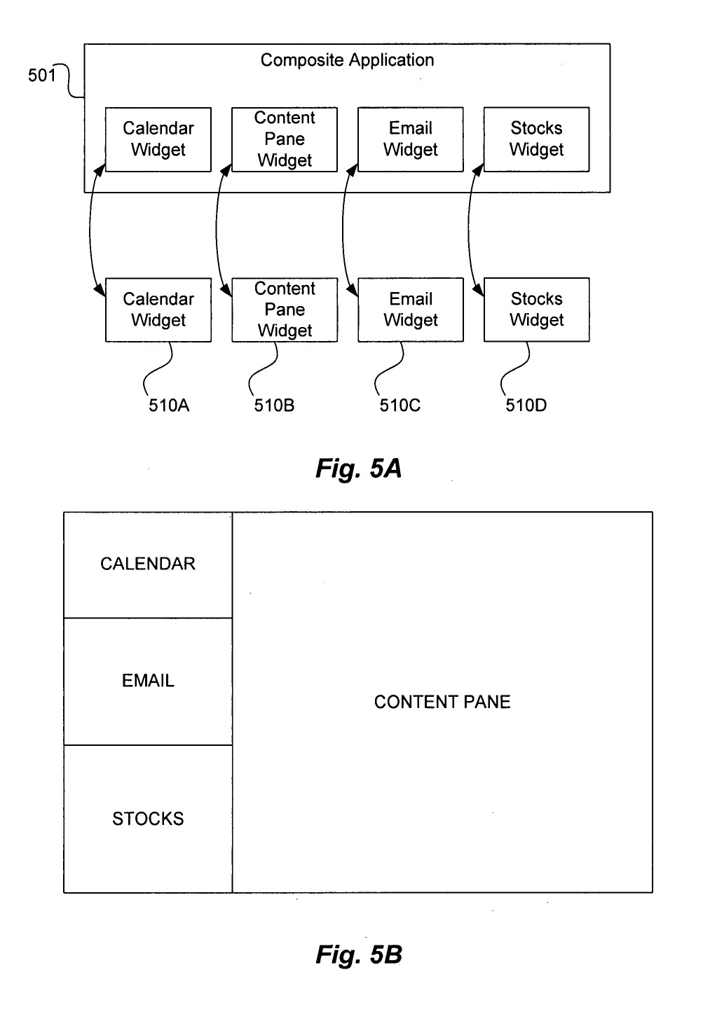

FIG. 5A-B show an example application composed from software components according to an embodiment of the present invention. In this example, a user is provided with a composite application 501 for associating a calendar widget 510A, a content pane widget 510B, an email widget 510C, and a stocks widget 510D. Composite application 501 may be used to encapsulate the application by relaying messages between widgets, for example. Calendar widget 510A may display a calendar to a user, and may allow a user to select particular days on the calendar, for example. Calendar widget 510A may generate an output message indicating the date selected (“DATE_SELECTED(DATE)”). Content pane 510B may display content to a user. For example, content pane 510B may receive input messages (e.g., content) from other widgets to be displayed to a user, such as the content of an email or particular stock graphs or data. Content pane 510B may generate output messages used by composite application 501 or other widgets in communicating with content pane 510B (e.g., error messages or instructions to other widgets). Email widget 510C may be used to access a database of emails. Email widget 510C may have inputs for specifying the constraints on the emails to be accessed and outputs of the content of the accessed emails. It is to be understood that email widget 510C is different from traditional mail programs in that it is a simple atomic component for accessing emails and providing the email outputs, and is not a fully-integrated fully-featured email system (e.g., Microsoft Outlook) for selecting, displaying, and manipulating emails. This example illustrates one aspect of the present invention. For example, embodiments of the present invention may be used to combine simple atomic program components to form customized applications. In this example, a stocks widget 510D may be used for accessing data about stocks. Stocks widget 510D may generate outputs that include such data, and may include information about how the data is to be presented to a user, for example.

Individual widgets may be selected and combined into container to create composite application 501. Container 501 may be a window displayed to a user or a background process invisible to a user. FIG. 5B illustrates an implementation where the container is a background process and not displayed to a user. After selecting widgets 510A-D, the widgets are displayed to a user as a single application as shown in FIG. 5B. In other embodiments, the widgets may be displayed as separate windows. Container 501 may control the display of the widgets by determining the widgets registered in the container and controlling the display of each associated widget. Widgets in the container may communicate information to operate as a single application. For example, a user may select a date on the calendar pane, which acts as an input for the calendar widget 510A. Calendar widget 510A may generate a message—“DATE_SELECTED(selected date)”—as an output. The message may be received by the container 501, which may route the message to all widgets in the container capable of receiving a “DATE_SELECTED” message. Accordingly, the container sends the message to the content pane 510B, email widget 510C, and the stocks widget 510D. In one embodiment, the content pane may display the date selected. The email widget 510C may receive the message and retrieve emails for the date selected. Email widget 510C may provide the emails as an output in a message—“EMAIL_SELECTED(EMAIL)”. The email message may be received by container 501 and routed to content pane 510B, which receives and displays the emails. Similarly, stocks widget 510D may receive the message and retrieve stock information for the date selected. Stocks widget 510D may provide the stock data as an output in a message—“STOCK_SELECTED(STOCK)”. The stock message may be received by container 501 and routed to content pane 510B, which receives and displays the stock information. This simple example illustrates how the container may be used to facilitate the flow of information between software components.

Based on the above example, those skilled in the art will understand that a variety of messages for each of the widgets may be used to enhance the user's experience and facilitate applications based on separate software components. As another example, email widget 510C may generate message that indicates classifications of emails (e.g., folders—Inbox, Outbox, etc . . . ). The message may be received by content pane 510B via container 501. Content pane 510B may display the classifications (e.g., folders) to a user for selection. A user may select “Inbox” in the content pane, which causes the content pane to send a message (e.g., GET_CONTENT(inbox)) to container 501. Container 501 may send the message to all associated components that provide the type of content in the message. For example, content requests from the content pane to the container may include objects (e.g., inbox) whose types may be examined by the container to determine which other components are capable of providing such objects. If the object is determined to be an email type object, the message is sent to email widget 50C. Email widget 510C may receive the message with information to access email classified as “Inbox,” and send the accessed emails to the content pane via the container. A user may select one email in the content pane, which causes the content pane to send a message to get the selected email (e.g., GET_CONTENT(email)). The message is routed to email widget 510C, which returns the content for the particular email selected to the content pane. The selected email is then displayed to a user in the content pane. From the above description, it will be evident to one skilled in the art that different message routing techniques may be used to control the flow of information between software components in a container and the role of the container in arbitrating the messages.

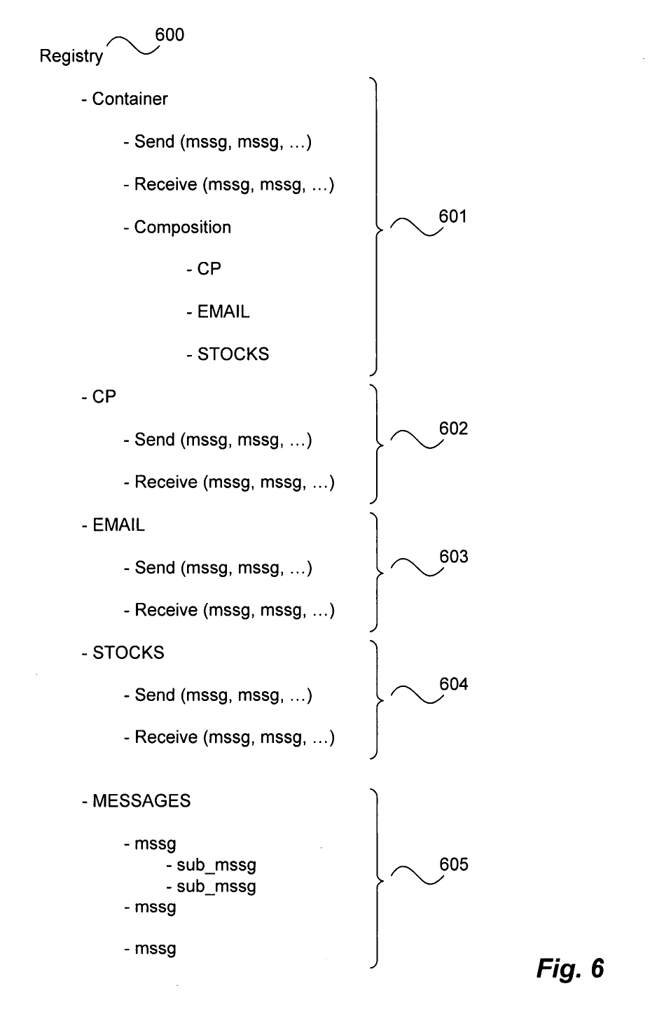

FIG. 6 shows an example registry of software components according to an embodiment of the present invention. In one embodiment, containers, associated software components, and messages may be included in a registry. The registry maintains a log of the types of software components in a container, and the types of messages sent and/or received by each software component. For example registry 600 may include an entry for a container 601, software components such as the content pane 602, email 603, stocks 604, and an entry for the types of messages flowing in the system 605. Container 601 may include a specification of the messages sent by the container and a specification of the messages received. The container specification may further include a list of the software components associated with the container. Accordingly, one step in association of a software component with a container may include creating an entry for the software component in the registry under a particular container. The composition of the container may include a list of a plurality of software components making up the composite application, for example. New software components may be automatically added to the composition as they are selected and moved into the container, for example, or software components may be automatically deleted from the composition if a user deletes or removes it. Additionally, the registry may include entries for each software component included as part of the composition, including specifications of the messages each software component may send or receive. Detailed specifications for the messages in a composite application may be further specified in the registry at 605. Message specifications may include detailed metadata definitions of the structure of each message. For example, a message may include attributes for storing parameters of the message. Messages may further include attributes that describe the message, specify a contact to obtain more information about the message, and specify a version. From the example above, messages may include “SHOW_CONTENT”, “DAY_SELECTED”, and “PERSON_SELECTED”. Example messages may include inheritance or sub-messages. For example, another message may be “BIRTH_DAY_SELECTED”, which may be inherited from “DAY_SELECTED”, for example. Additionally, sub-messages may include mouse clicks such as “MOUSE_CLICK(SCREEN_COORDINATES, BUTTON_STATE, COMPONENT_INSTANCE_ID),” where screen coordinates, button state, and component instance ID may be parameters of the sub_message. Messages may also be independent, so each message may have encapsulated methods that are not part of any software component or the container.

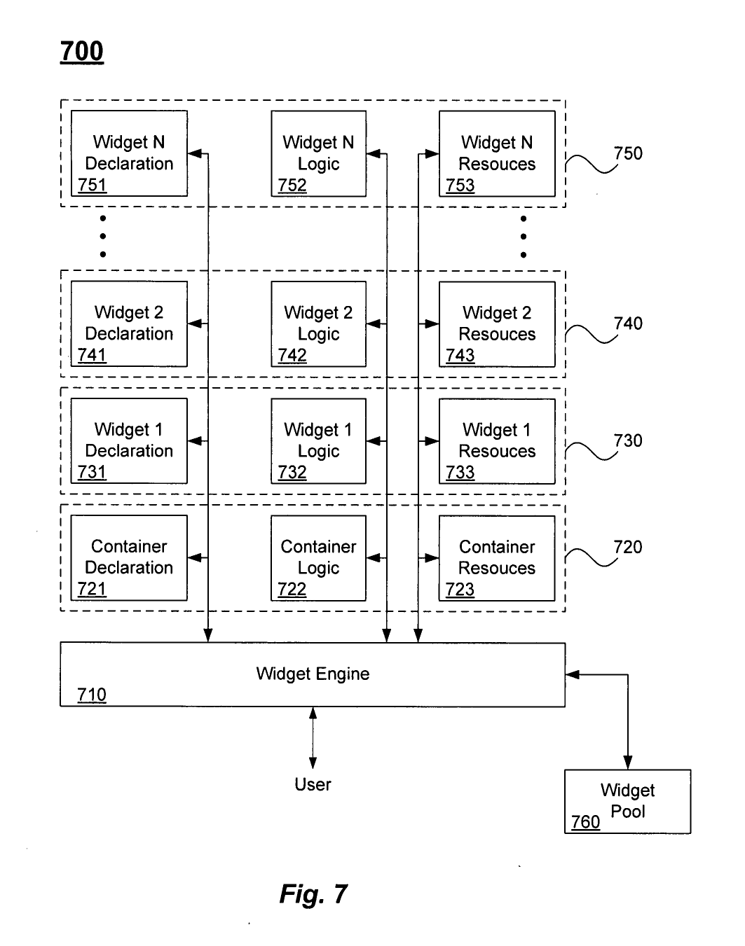

FIG. 7 shows an example implementation of a customizable application according to an embodiment of the present invention. In this example, atomic widgets are combined in a widget engine to create composite applications. A widget engine is an execution engine that takes the definition of a widget and executes the widget. Widget engine 710 may allow a user to combine any functionality by combining different widgets with different features and functions. A container widget may include a container declaration 721, container logic 722, and container resources 723, if any. Container declaration 721 declares the structure as a container, and may include software constructs for accessing services or functionality that may be used by the container. The declarations may be represented in a dialect of XML to declare the structure of the declaration. Container logic 722 is the software logic implementing some or all of the containers functionality, including the container interfaces, messaging, and processing. Container logic 722 may perform routing, display, and transformation functions required by the container, for example. Logic may be implemented in programming languages such as Java or C++, for example. Container resources 723 may include images, sounds, or other forms of content used by the container. For example, the container may have an associated image for representing the container in a GUI. The image may be accessed when the container is selected in the GUI. Similarly, one sound may be used to notify a user that a widget has been successfully added to the container, and another sound may be used to notify a user that a widget is not compatible, for example. Widgets in a container may also include declarations, logic, and resources. Widget declarations may access web service or include HTTP, or SOAP calls, for example. For example, widget 730 includes a widget declaration 731, widget logic 732, and widget resources 733. The declarations may be read and parsed by widget engine 710. The widget engine may read and interpret a declaration and use the information to setup and control interaction between the container and widgets. The widget engine may access the logic and resources of each component as the component's functionality is activated. The widget engine may then access web services or resources associated with a particular widget's functionality, widget logic, widget resources as needed as part of a composite application designed by a user from atomic widgets. The widget engine may determine the list of active widgets in a composite application by accessing a widget pool 760. Widget pool 760 may be a list of widgets available to a system, LAN, WAN, wireless network, or the Internet, for example. In some embodiments, the widget pool 760 may be maintained separate from the widget engine 7 1 0. In other embodiments, the information stored in widget pool 760 may integrated into the functionality of widget engine 710.

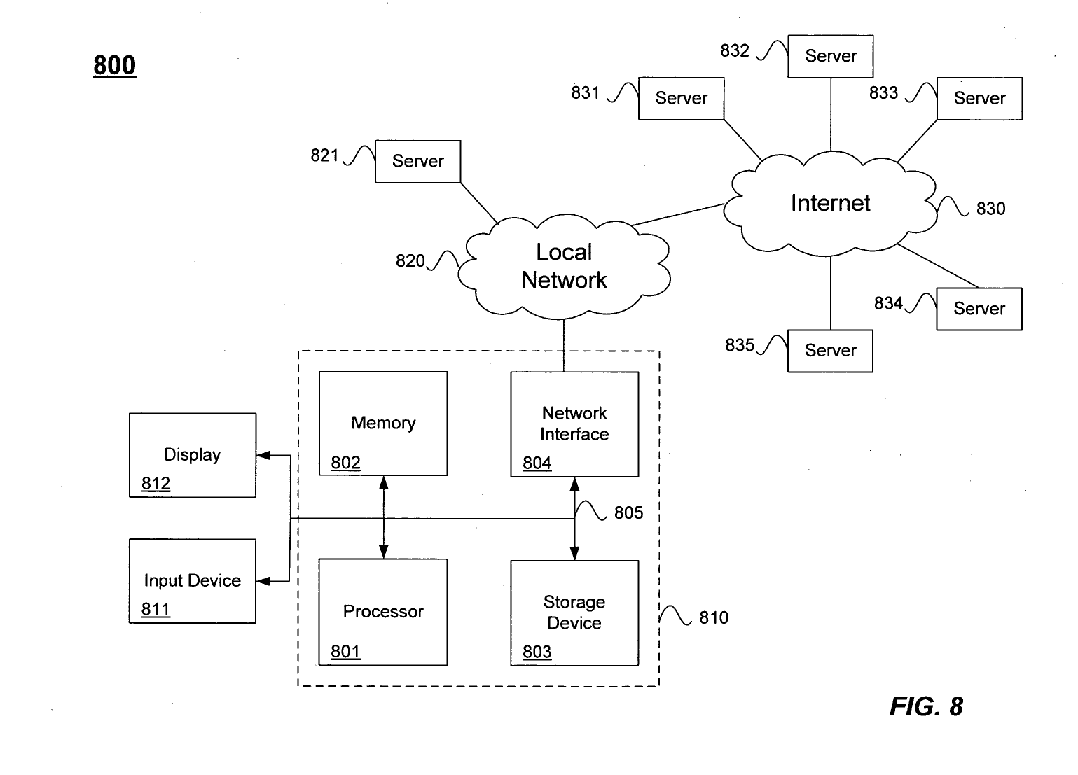

FIG. 8 illustrates an example computer system and networks that may be used to implement one embodiment of the present invention. Computer system 810 includes a bus 805 or other communication mechanism for communicating information, and a processor 801 coupled with bus 805 for processing information. Computer system 810 also includes a memory 802 coupled to bus 805 for storing information and instructions to be executed by processor 801, including instructions for performing the techniques described above. This memory may also be used for storing temporary variables or other intermediate information during execution of instructions to be executed by processor 801. Possible implementations of this memory may be, but are not limited to, random access memory (RAM), read only memory (ROM), or both. A storage device 803 is also provided for storing information and instructions. Common forms of storage devices include, for example, a hard drive, a magnetic disk, an optical disk, a CD, a DVD, a flash memory, a USB memory card, or any other medium from which a computer can read.

Computer system 810 may be coupled via the same or different information bus, such as bus 805, to a display 812, such as a cathode ray tube (CRT) or liquid crystal display (LCD), for displaying information to a computer user. An input device 811 such as a keyboard and/or mouse is coupled to a bus for communicating information and command selections from the user to processor 801. The combination of these components allows the user to communicate with the system.

Computer system 810 also includes a network interface 804 coupled with bus 805. Network interface 804 may provide two-way data communication between computer system 810 and the local network 820. The network interface 804 may be a digital subscriber line (DSL) or a modem to provide data communication connection over a telephone line, for example. Another example of the network interface is a local area network (LAN) card to provide a data communication connection to a compatible LAN. Wireless links is also another example. In any such implementation, network interface 804 sends and receives electrical, electromagnetic, or optical signals that carry digital data streams representing various types of information.

Computer system 810 can send and receive information, including messages or other interface actions, through the network interface 804 to an Intranet or the Internet 830. In the Internet example, software components or services may reside on multiple different computer systems 810 or servers 831 across the network. Software components described above may be implemented on one or more servers. A server 831 may transmit messages from one component, through Internet 830, local network 820, and network interface 804 to a component or container on computer system 810, for example. Software components of a composite application may be implemented on the same system as other components, or on a different machine than other software components. This process of sending and receiving information between software components or one or more containers may be applied to communication between computer system 810 and any of the servers 831 to 835 in either direction. It may also be applied to communication between any two servers 831 to 835.

The above description illustrates various embodiments of the present invention along with examples of how aspects of the present invention may be implemented. The above examples and embodiments should not be deemed to be the only embodiments, and are presented to illustrate the flexibility and advantages of the present invention as defined by the following claims. Based on the above disclosure and the following claims, other arrangements, embodiments, implementations and equivalents will be evident to those skilled in the art and may be employed without departing from the spirit and scope of the invention as defined by the claims.

What is claimed is:

1. A method of composing a software application comprising:
selecting a plurality of software components, wherein each software component includes a predefined functionality;
determining the compatibility of the selected software components with a first container;
associating the software components with the first container if the software components are compatible with the first container; and
activating the first container, and in accordance therewith, activating the predefined functionality of each of the plurality of associated software components.

2. The method of claim 1 wherein the first container comprises one or more interfaces for communicating information between different software components.

3. The method of claim 1 wherein the first container is displayed to a user, and the user drags and drops different software components into the first container to create an association between the software components and the first container.

4. The method of claim 1 further comprising registering the plurality of software components and messages sent or received by each software component.

5. The method of claim 7 wherein registering comprises storing specifications of the messages sent or received by each software component.

6. The method of claim 7 wherein registering comprises storing metadata definitions of the structure of each message.

7. The method of claim 1 wherein the associated software components receive data from an external source.

8. The method of claim 1 wherein at least one of the associated software components includes an input for receiving data from another software component associated with the first container or an output for sending data to another software component associated with the first container.

9. The method of claim 1 wherein
a first software component associated with the first container includes an input coupled to an external data source;
a second software component includes an input for receiving data from another software component associated with the first container;
a third software component includes an output for sending data to another software component associated with the first container; and
a fourth software component includes an input for receiving data from one or more other software components associated with the first container and an output for sending data to one or more other software components associated with the first container.

10. The method of claim 1 further comprising:
selecting a second container comprising a second plurality of software components, wherein each of the second plurality software components includes predefined functionality;
determining the compatibility of the second plurality of software components with the first container;
associating the second container with the first container if the second plurality of software components are compatible with the first container; and
activating the first container, and in accordance therewith, activating the predefined functionality of each of the second plurality of associated software components.

11. The method of claim 1 wherein software components are atomic units that are fully functional independent of other components in the first container.

12. The method of claim 1 further comprising reusing the first container.

13. The method of claim 12 wherein reusing comprises creating a plurality of instances of the container.

14. The method of claim 12 wherein reusing comprises creating a plurality of links to the container.

15. The method of claim 1 wherein the first container comprises a container declaration, container logic, and container resources, the plurality of software components each comprise a declaration, logic, and resources, and wherein the method is executed by a software engine.

16. The method of claim 15 further comprising registering the software components in a pool.

17. The method of claim 15 wherein the software components are software widgets.

18. A computer software system comprising:
a software engine;
a first container; and
a plurality of software components associated with the first container, each software component having predefined functionality,
wherein a user associates compatible software components with the first container to create a composite application including the functionality of each of the software components, and wherein the plurality of software components are automatically activated by the software engine if the first container is activated.

19. The computer software system of claim 18 wherein the first container comprises a container declaration, container logic, and container resources, the plurality of software components each comprise a declaration, logic, and resources.

20. The computer software system of claim 18 wherein the software components are software widgets.

21. The computer software system of claim 18 wherein the first container comprises one or more interfaces for communicating information between different software components.

22. The computer software system of claim 18 wherein the first container is displayed to a user, and the user drags and drops different software components into the first container to create an association between the software components and the first container.

23. The computer software system of claim 18 further comprising a registry for specifying the plurality of software components and messages sent or received by each software component.

24. The computer software system of claim 23 wherein registering comprises storing specifications of the messages sent or received by each software component.

25. The computer software system of claim 23 wherein the registry comprises metadata definitions of the structure of each message.

26. The computer software system of claim 18 further comprising:
a second container; and
a second plurality of software components associated with the second container, each software component having predefined functionality,
wherein a user associates the second container with the first container to create a composite application including the functionality of each of the first and second plurality software components, and wherein the first and second plurality of software components are automatically activated by the software engine if the first container is activated.
